(19) United States
(12) Patent Application Publication
(10) Pub. No.: US 2015/0202646 A1
(43) Pub. Date: Jul. 23, 2015

(54) TOOL AND METHOD FOR SHEATHING AN ELONGATE PRODUCT AVAILABLE BY THE METER

(71) Applicant: Fraunhofer-Gesellschaft zur Foerderung der angewandten Forschung e.V., Muenchen (DE)

(72) Inventors: Andreas Fischer, Blumberg (DE); Steve Rommel, Stuttgart (DE); Raphael Geiger, Stuttgart (DE); Stefan Weber, Besigheim (DE)

(73) Assignee: Fraunhofer-Gesellschaft zur Foerderung der angewandten Forschung e.V., Muenchen (DE)

(21) Appl. No.: 14/421,651

(22) PCT Filed: Aug. 13, 2013
(86) PCT No.: PCT/EP2013/002433

§ 371 Date: Feb. 13, 2015

(30) Foreign Application Priority Data
Aug. 16, 2012 (DE) 10 2012 016 248.0

(51) Int. Cl. B05C 1/04; B05D 7/00

(52) U.S. Cl. CPC B05C 1/04; B05D 7/00; B05D 2203/00; B05D 2256/00

(57) ABSTRACT

A tool and a method are described for sheathing an elongated product available by the measured length, in particular in the form of a fiber or a fiber bundle, with at least one thermoplastic layer, with a wetting unit comprising at least one contact zone that can be filled with a flowable thermoplastic, through which the elongated product can be guided for the purpose of wetting with the thermoplastic in the form of a continuously progressing strand. The invention has a first feeding area for the elongated product and a second feeding area for the thermoplastic to emerge into the at least one contact zone. The contact zone comprises at least one outlet area and has a means is provided along the second feeding area, by which the thermoplastic can be introduced, subject to pressure, into the contact zone in the direction of the outlet area. The elongated product guided into the contact zone is carried along lengthwise through the outlet area by the thermoplastic solely by way of frictional force between the thermoplastic and the elongated product.

### CROSS-REFERENCE TO RELATED APPLICATION

Reference is made to German Application Serial No. 10 2012 016 248.0, filed Aug. 16, 2012 and PCT Application PCT/EP2013/002433, filed Aug. 13, 2013, which applications are incorporated herein by reference in their entirety.

### TECHNICAL FIELD

1. Field of the Invention

The invention relates to a tool and a method for sheathing an elongated product available by the measured length, in particular in the form of a fiber or a fiber bundle, with at least one thermoplastic layer, with a wetting unit comprising at least one contact zone that can be filled with a flowable thermoplastic, through which the elongated product can be guided for the purpose of wetting the product with the thermoplastic in a continuously progressing strand.

2. Description of the Prior Art

A generic method for coating an elongated product in the form of a wire with a thermally meltable material is described in DE-OS-27 33 075 with the thermally meltable material being present as a heated liquid bath inside a housing. The housing provides a housing section with two housing openings which are disposed vertically with one being above the other and through which the wire available by the measured length is guided uniaxially vertically through the housing from the bottom to the top. As a result, the wire is wetted externally with the material present in molten form. The wire which is guided vertically upwards and sheathed with molten material is cooled immediately after exiting from the liquid bath which causes the sheathing material to solidify. The wire is drawn through the housing filled with molten material by motor-driven rollers at a preselected conveying speed.

A method for producing an optical fiber is described in DE 42 26 343 A1, wherein the optical fiber drawn from a glass pre-form in a guided direct process sequence through a coating device, in which coating material is held in liquid form. The coating material is deposited on the surface of the optical fiber in a material layer. The coated optical fiber directly emerging from the coating device is fed through a protective gas atmosphere for the purpose of rapid curing and cross-linking of the coating layer.

Publication DE 41 21 677 A1 describes a method for coating an optical fiber in a pressure coating vessel, which stores a pressurized quantity of lacquer. The pressure coating vessel comprises two openings for leading an optical fiber. The openings are provided in mutually opposite vessel walls and are sealed against leakages. The pressure control inside the pressure coating vessel provides a layer of deposition that has as uniform thickness as possible in association with the drawing speed at which the optical fiber is drawn through the coating vessel.

U.S. Pat. No. 5,749,971 discloses a device for coating welding electrodes with a flux. The welding electrode is conveyed by a guiding unit through a coating unit which is nozzle-shaped and in which the welding electrode is sheathed with the liquid flux, which is fed to the coating unit via lateral supply lines.

Publication D10 2010 045 279 A1 describes a device for producing molded bodies coated with polymers, which in particular, is for coating fibers and filaments. Transport rollers draw a fiber to be coated through a guide tube into a bath with liquid polymer and then is guided through an aperture at which excess polymer is stripped away. Finally, the fiber coated with polymer passes via further transport rollers, under mechanical stress in a relaxation section to provide alignment of the polymers.

All the known coating devices and methods for elongated products available by the measured length have in common the fact that the devices are usually constituted with a large and heavy structure and do not therefore appear suitable for use as portable tools. For example, it would be desirable to combine such tools with movably guided robot arms, in order to use the freshly sheathed elongated product while the sheathing material whereof is not yet solidified or cured, for the purpose of providing individual spatial layering for building up three-dimensional structures. In all the known cases, costly conveying and transport mechanisms are required, with which the elongated product to be coated has to be conveyed through a suitably designed coating device.

### SUMMARY OF THE INVENTION

The invention provides a tool and a method for sheathing an elongated product available by the measured length, which is in particular, in the form of a fiber or a fiber bundle, with at least one thermoplastic layer. A wetting unit is used comprising at least one contact zone that can be filled with a flowable thermoplastic, through which the elongated product can be guided for the purpose of wetting with the thermoplastic in the form of a continuously progressing strand. The sheathing process of the elongated product with at least one layer of thermoplastic material is carried out with a reduced number of components compared to the prior art, so that the tool used for the sheathing is as compact and small as possible. In particular, the goal is to provide delivery of the elongated product sheathed with thermoplastic material immediately after exit from the tool in the form of a progressing strand along a three-dimensionally predetermined laying path from the tool. The means and components required to implement the tool of the invention should be as low-cost as possible and enable straightforward handling in terms of the process.

The tool according to the invention is based on a material delivery nozzle, from which at least one sticky flowable material, for example in the form of a softened flowable thermoplastic, is conveyed, under pressure, through a nozzle body to form a continuous material strand. The sticky consistency of the strand directly after exiting from the nozzle body depends on the selected material. The material undergoes a material curing process usually by cooling and/or by light-induced cross-linking processes. The tool according to the invention for sheathing an elongated product available by the measured length uses a conveying process employing force or pressure applied to a heated thermoplastic which flows by heating is made flowable while being conveyed through a nozzle body, which is referred to hereinafter as a wetting unit. The elongated product available by the measured length in loose form is introduced, via an entrance to the wetting unit, into the conveying while in a thermally softened and flowable thermoplastic material state that passes, under pressure or force, through the wetting unit. In the wetting unit the elongated product is enclosed by the flowable thermoplastic as much as possible along its peripheral edge. On account of the adhesion-induced frictional forces acting between the elongated product surface and the thermoplastic flowing through the wetting unit, the elongated product is properly carried along in the flow direction of the flowable thermoplastic. On account of the tractive force caused by frictional engagement arising along the elongated product in the direction of the flow or conveying direction of the flowable thermoplastic, there is no need for a further motor-driven conveying device assisting the infeed or outfeed of the elongated product into or through the wetting unit. As a result of the invention not using any motor-driven conveying mechanisms for the elongated product, the objective of the wetting unit to be as small, compact and lightweight as possible, its use in a portable unit on a manipulator end arm of a robotic unit is possible. Since the thermoplastic material sheathing the elongated product is in a sticky state immediately after removal from the tool, the material strand exiting from the tool is preferentially suited for the production of two- and in particular three-dimensional components, which can be produced by depositing the elongated product sheathed with the thermoplastic in successive steps immediately one after another. Fibers, for example continuous fibers, fiber bundles, staple fiber yarn etc., sheathed with thermoplastic are particularly suitable for this.

According to the invention, a tool is provided for sheathing an elongated product available by the measured length, in particular, a fiber or a fiber bundle, with at least one thermoplastic layer, with a wetting unit comprising at least one contact zone that can be filled with a flowable thermoplastic, through which the elongated product can be guided for the purpose of wetting with the thermoplastic in the form of a continuously progressing strands. The tool is characterized by at least a first feeding area for the elongated product and at least a second feeding area for the thermoplastic to emerge into the at least one contact zone. The contact zone comprises at least one outlet area, through which the elongated product sheathed with the thermoplastic exits from the wetting unit. Furthermore, a means is provided along the at least second feeding area, for introducing the thermoplastic, subject to pressure, into the contact zone in the direction of the outlet area. The elongated product guided into the contact zone is carried along lengthwise through the outlet area by the thermoplastic solely by way of frictional force between the thermoplastic and the elongated product.

With regard to providing and feeding the elongated product by the measured length, preferably in the form of a continuous fiber, no motor-assisted measures whatsoever are required. As a result, the elongated product can be fed in loose form, that is force-free, into the first feeding area.

For reasons of simple handling and feeding of the thermoplastic material through the first feeding area of the wetting unit, the thermoplastic is made available in the form of a solid strand, which is guided acted upon by force, through the second feeding area in the direction of the contact zone by a suitable conveying unit. Particularly, suitable conveying units are motor-driven conveying rollers or wheels, which are provided along the second feeding area preferably in pairs each rotating in opposite directions which cause local contact in a friction-locking manner with both sides of the thermoplastic strand to be conveyed and convey the same in the direction of the contact zone. For the purpose of melting the thermoplastic strand present in a solid form, a heating unit is provided in the region of the contact zone and/or along the second feeding area. The heating unit heats the solid thermoplastic material which is transformed into the flowable state, so that the flowable thermoplastic finally fills, under the effect of pressure, at least a partial region of the contact zone. In order to prevent the flowable thermoplastic from escaping, against the conveying direction, through the second feeding area with a flow direction directed backwards, the second feeding area encloses the solid thermoplastic strand along its circumferential direction in a fluid-tight manner to prevent escape of flowable thermoplastic. The flowable thermoplastic passes, as a result of the first feeding area and the contact zone, having a predetermined flow direction orientated in the direction of the outlet area into the contact zone. The elongated product which is fed into the contact zone via the first feeding area is held solely by the flow dynamics of the flowable thermoplastic flowing through the contact zone and is carried along in the direction of the outlet area. Comprehensive wetting of the elongated product with the flowable thermoplastic occurs and the flowable thermoplastic at least partially penetrates the elongate product depending on the material and consistency of the elongate product. If the elongate product fed into the contact zone is, for example, fiber bundles composed of individual fibers or fibers comprising individual fiber filaments, such as for example carbon or plastic fiber strands, a proper and complete saturation of elongate product with the flowable thermoplastic takes place inside the contact zone.

The wetting unit, is a nozzle body and comprises at least two previously described feeding areas, which are a contact zone and an outlet area, is produced with generative production techniques, so that the wetting unit according to the invention is scalable as required and from heat[-] and pressure-resistant material, which is preferably metal.

Fiber composite materials can be produced in an automated manner with the tool constituted according to the invention, in an economically acceptable manner even from single batches.

An advantageous embodiment provides a severing device along the first feeding area through which the elongated product is introduced into the wetting unit. The severing device makes it is possible to interrupt the feeding of the elongated product merely by severing, so that the sticky flowable thermoplastic strand exiting from the tool does not include any fibers. In this way, the tool serves as a delivery nozzle of a material strand solely comprising flowable thermoplastic material. It is possible at any time, however, to resume the feed of the loosely stored elongated product to the wetting unit. For this purpose, the wetting unit comprises a separate conveying device for providing a controlled introduction of the elongated product through the first feeding area into the contact zone under pressure by the flowable thermoplastic. From the contact zone the elongated product is again carried along by frictional engagement through the outlet area of the wetting unit by the thermoplastic.

With the tool according to the invention, which can be robot-guided in a translatory, as well as a rotational manner, preferably around at least three spatial axes, fiber-reinforced composite components can be produced by the generative production process which provide significantly improved component strength resulting from the presence of the fiber component inside the building material compared to conventionally produced components that have been produced by means of the generative layer build-up technique. In addition, the tool according to the invention enables, through the previously described severing and conveying device for the elongated product, a selective build-up of the material-reinforcing fiber component preferably only at those points and regions inside a component to be produced generatively that are subjected to a particularly high load, while other regions of the component which are subjected to only small loads can be built up solely from thermoplastic. No process interruptions are required either for the interruption of the fiber feed during an otherwise continuous thermoplastic delivery, or for resuming the feed of the fibers, that is the generative production process can be carried out free from interruptions. In addition, the material costs and therefore the production costs are reduced considerably as a result of the selective use of the elongated material which is fed, especially in the case of large-volume components.

Preferred examples of embodiment for implementing a tool according to the invention for the sheathing of an elongated product available by the measured length are explained below.

### BRIEF DESCRIPTION OF THE DRAWINGS

The invention is described below by way of example without restriction of the invention on the basis of examples of embodiment making reference to the drawings. In the figures:

FIG. 1 shows a longitudinal cross-section through a diagrammatic representation of a tool according to the invention;

FIGS. 2a and b show a first embodiment of a tool according to the;

FIG. 3 shows a second embodiment of a tool according to the invention;

FIG. 4 shows an additional device for a second embodiment of the invention;

FIG. 5 shows a combination of the first and second embodiments; and

FIG. 6 shows a third embodiment of a tool according to the invention.

### DETAILED DESCRIPTION OF THE INVENTION

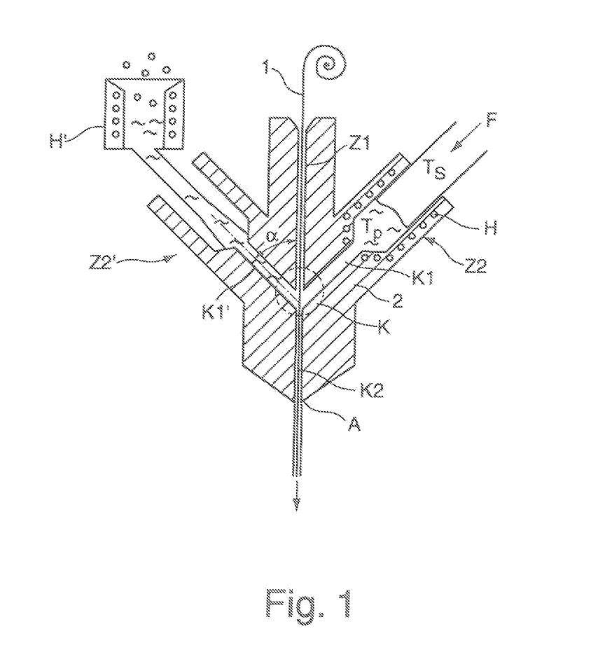

FIG. 1 shows a longitudinal cross-section through a tool according to the invention for sheathing an elongated product 1 available by the measured length, which is made available loose to wetting unit 2 represented in cross-section. The elongated product passes via a first feeding area Z1 into wetting unit 2. Typically, first feeding area Z1 is a hollow channel which completely penetrates the wetting unit 2 and which emerges in an outlet area A open in the lower end of wetting unit 2. Furthermore, at least a second feeding area Z2 is provided, through which flowable thermoplastic T_{f} is fed into a contact zone K, through which elongated product 1 is guided in a loose form.

To illustrate two differently constituted second feeding areas, reference is first made to the right-hand side of the cross-sectional diagram represented in FIG. 1. A second variant is shown by the left-hand side of the cross-sectional diagram, to which reference will be made below. [-] Flowable thermoplastic T_{f} is made available in the case illustrated in FIG. 1 in the form of a solid thermoplastic strand Tₛ, which is introduced, under force, into a widened region of second feeding area Z2, which is heated with a heating device H. The thermoplastic softens through thermal contact of the solid thermoplastic strand guided under pressure towards second feeding unit Z2 and is transformed into the liquid state and passes, under pressure, into contact zone K, which is indicated in FIG. 1 by a dashed circle, in which elongated product 1 is located. Flowable thermoplastic T_{f} passes into contact zone K with a flow direction predetermined by the channel geometry of second feeding area Z2 and emerges into continuing channel section K2, which emerges at outlet area A. In contact zone K, the elongated product is thus carried along by frictional contact between flowable thermoplastic T_{f} and elongated product 1 through channel section K2 in the direction of outlet area A. The elongated product sheathed with the thermoplastic exits downwardly.

A further alternative for a pressure feeding of liquid thermoplastic into contact zone K is illustrated in the left-hand half of the represented cross-sectional diagram according to FIG. 1. In contrast with the case already explained, thermoplastic Tₛ is made available as a solid granulate and is introduced into a heating arrangement device H′ provided for melting the granulate grains. Heating device H′ is in fluid communication indirectly or directly with feeding area Z2′ of wetting unit 2, along which flowable granulate T_{f} passes, under pressure, into contact zone K. Feeding channel K1′ of the second feeding area Z2′ emerges into contact zone K at an angle α, ranging from: 10°<=α<=80°, with preferably α<=45°. This ensures that the flow of flowable thermoplastic T_{f} passing into contact zone K has a flow direction orientated in the direction of channel section K2, as a result of which the elongated product 1, which is guided along first feeding area Z1, is carried along through outlet opening A by frictional engagement produced along channel section K2.

The two examples of the embodiment illustrated in FIG. 1 for the implementation of a force feed of a flowable thermoplastic into the contact zone can each be separate from one another and also in combination within a single wetting unit 2. Wetting unit 2 therefore represents a one-piece body having nozzle form, which can be produced by generative production techniques, such as, for example, selective laser melting etc. In a preferred embodiment, wetting unit 2 is made of a metallic material which possesses a high thermal conductivity, in order to ensure that, for example, a heating device H which is integrated into wetting unit 2, as is the case in the example of embodiment according to FIG. 1 in the right-hand side, can feed thermoplastic material Tₛ present in solid form to be fed into the melt.

Wetting unit 2 can be scaled arbitrarily and can be separated for the most diverse applications. As a result of the absence of any conveying mechanisms for conveying elongated product 1 through wetting unit 2, the tool can be particularly small and lightweight and is therefore in principle suitable for attachment to robot-guided manipulator end arms.

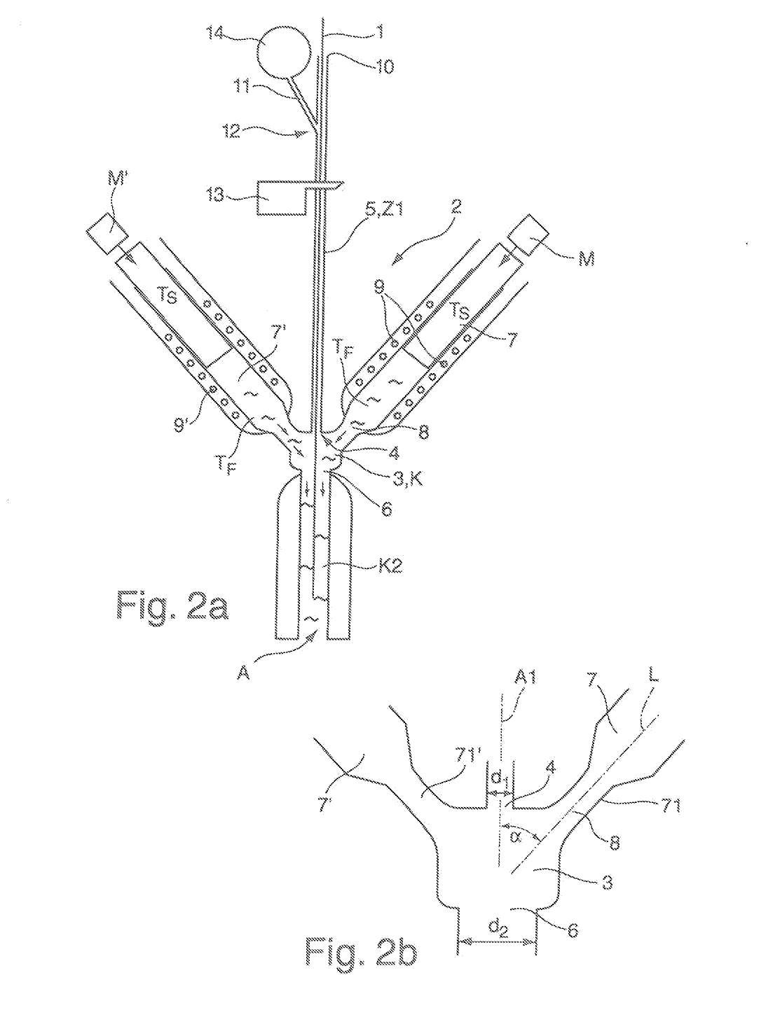

FIG. 2a shows, in a diagrammatic representation, the main components of a tool according to the invention for sheathing an elongated product 1 with thermoplastic material. In the same way as in FIG. 1, the tool provides as first feeding area Z1 a feeding channel 5, which comprises an upper channel opening 10 and an inlet opening 4 emerging in contact zone K which is a chamber 3. An elongated product 1, preferably in the form of fibers, such as continuous fibers, fiber bundles or staple fiber yarns etc., is guided loosely through feeding channel 5. Provided coaxially at inlet opening 4, lying opposite chamber 3, is an outlet opening 6, having diameter d2 which is preferably dimensioned larger than diameter d1 of feeding channel 5 at the location of inlet opening 4. To illustrate the chamber geometry, reference is made to the detailed representation in FIG. 2b, which shows chamber 3 with the adjacent supply and discharge lines, as explained below.

A second feeding area Z2 which is a conveying line 7 emerges in chamber 3 at the side of feeding channel 5, through which second feeding area flowable thermoplastic is introduced into chamber 3. Conveying line 7 emerges into chamber 3 via a line section 71 tapered in cross-section, wherein line section 71 has a line axis L which is inclined obliquely with respect to axis A1 of feeding channel 5 and forms an angle α therewith, which ranges between 10° and 80° and preferably is 45°±20°. The oblique emergence of conveying line 7, or 71, into chamber 3 ensures that the material flow of flowable thermoplastic flowing through conveying line 7 or 71 into chamber 3 has a flow direction that is orientated in the direction of outlet opening 6. In addition, chamber 3 comprises a chamber wall inner contour which assists an outflow of flowable thermoplastic introduced into chamber 3 through outlet opening 6.

Chamber 3 also comprises a concentric, preferably circular chamber wall surrounding elongated product 1 guided through chamber 3, so that the thermoplastic material introduced into chamber 3 is able to enclose or to fully wet elongated product 1.

Not necessarily, but in an advantageous form, a further conveying line 7′ is provided symmetrically with respect to axis A1. The further conveying line similarly emerges via a line section 71′ into chamber 3. Uniform sheathing of elongated product 1 with thermoplastic material is achieved from a symmetric feed of flowable thermoplastic into chamber 3.

As already mentioned by reference to FIG. 1, the feed of thermoplastic takes place as a solid thermoplastic strand Tₛ, which is pushed, acted upon by force, into individual conveying lines 7, 7′. M and M′ press solid thermoplastic strand Tₛ respectively along conveying lines 7 and 7′. A heating device 9 and 9′ provided along conveying line 7 and 7′ melts the end of solid thermoplastic strand Tₛ that faces chamber 3.

The feeding of flowable thermoplastic material T_{F} into chamber 3, the feed being symmetrical and lengthwise with respect to axis A1, the elongated product 1 emerging loosely through feeding channel 5 into chamber 3 are carried along by friction acting in the direction of outlet opening 6. Typically, outlet opening 6 is followed by a further flow channel K2, which opens at outlet area A of the tool.

A severing device 13 is also provided along feeding channel 5, severs, as required, the elongated product 1 guided through feeding channel 5. Severing techniques, which are known to persons skilled in the art, are available to provide the severing device. For example, a mechanical severing device having a blade mounted movably at the side of feeding channel 5, or a thermal severing device, having a hot-wire, which is capable of severing the elongated product locally by melting, etc. may be utilized

By use of the severing device 13, it is possible to use the tool, as required, for the exclusive delivery of thermoplastic material through the outlet opening without the feeding of an elongated product.

In order to feed elongated product 1 into the region of chamber 3 for a renewed delivery through the tool, a conveying device 14 is provided along feeding channel 5 in the region between upper inlet opening 10 and severing device 13. The conveying device may, for example, have a compressed air source which feeds compressed air into feeding channel 5 via a connecting channel 11, which causes the elongated product 1 to emerge loosely into feeding channel 5 and be pushed or blown in the direction of chamber 3. As soon as elongated product 1 comes into contact with flowable thermoplastic T_{F} in the region of chamber 3, elongated product 1 is carried along by the thermoplastic flow.

If elongated product 1 is, for example, a fiber with a very smooth surface, such as is the case for example with optical fibers, a motor-driven roller pair in the region of inlet opening 10, which causes the elongated product 1 to contact the flowable thermoplastic in chamber 3, is suitable as conveying device 14 instead of a compressed air source.

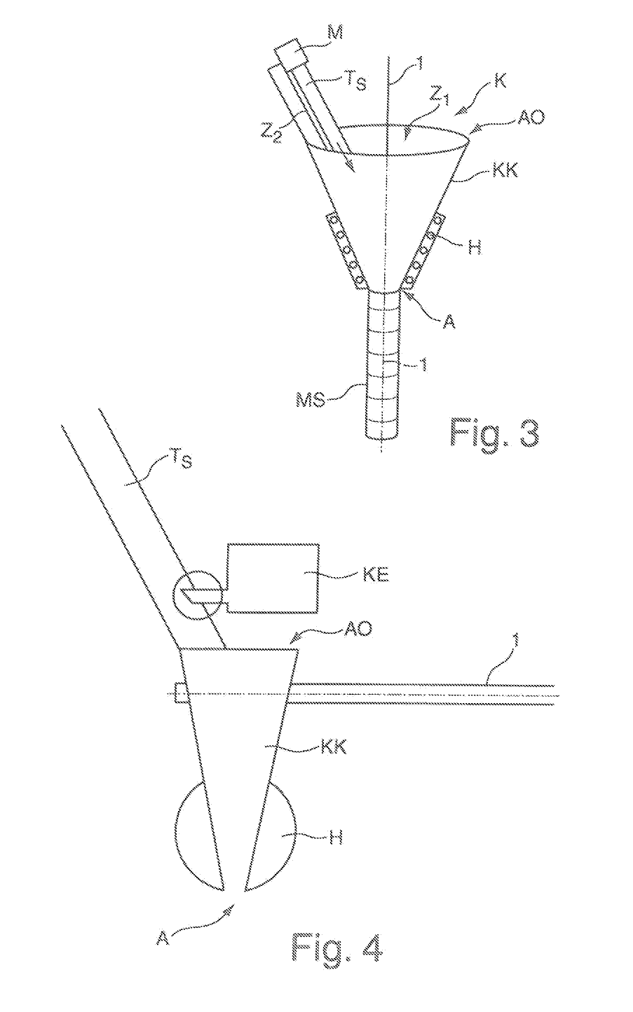

FIG. 3 shows a further embodiment for the implementation of the tool, wherein first and second feeding area Z1 and Z2 emerge in a conically constituted chamber KK, which has a wall contour tapering conically in the direction of outlet area A. Conical chamber KK comprises a funnel-shaped receiving opening AO disposed opposite outlet area A, relative to which a device M is spatially fixed, for introducing the thermoplastic material as a solid thermoplastic strand Tₛ under pressure, into conical chamber KK in the direction of outlet area A. In addition, loosely conveyed elongated product 1 emerges through receiving opening AO into conical chamber KK. Located at least in the region of outlet area A is a heating device H disposed in thermal contact with conical chamber KK, which heats the thermoplastic strand Tₛ to provide transformation into a flowable form.

Elongated product 1 exits together with the thermoplastic material as material strand MS through outlet area A.

FIG. 4 illustrates a design option with which, on the basis of the example embodiment shown in FIG. 3, the feeding of elongated product 1 can be interrupted, so that only a material strand of thermoplastic material can be delivered through outlet area A of conical chamber KK. For this purpose, a notching device KE is provided in the conveying direction along thermoplastic strand Tₛ before receiving opening AO of conical chamber KK, locally notch the stand Tₛ as the thermoplastic strand Tₛ is being fed.

In contrast with the example of embodiment according to FIG. 3, elongated product 1 is not guided through receiving opening AO into conical chamber KK. Instead, the product 1 is introduced laterally into conical chamber KK, as seen from the diagrammatic representation according to FIG. 4.

Elongated product 1 thus extends crosswise to the feeding direction of thermoplastic strand Tₛ through the upper region of conical chamber KK, in such a way that elongated product 1 lies adjacent to the surface of thermoplastic strand Tₛ. When the surface notch of thermoplastic strand Tₛ passes into the region of elongated product 1, elongated product 1 flows into the notch and is carried along by thermoplastic strand Tₛ in the direction of conical chamber KK and guided through outlet area A.

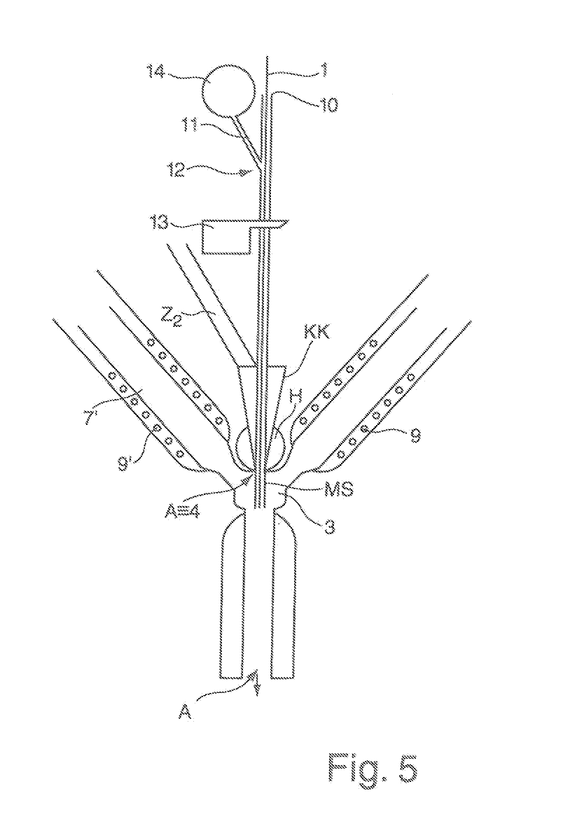

It is also possible to combine conical chamber KK illustrated in FIG. 3 with the tool shown in FIG. 2. Such a combination is shown in FIG. 5. Here, outlet area A of conical chamber KK corresponds to inlet opening 4 of chamber 3 of the tool. There is no change to the tool arrangement according to FIG. 5 with regard to the mode of functioning of all the previously described components. The only difference with regard to the tool according to FIG. 2 is that a material strand MS sheathed with thermoplastic enters into chamber 3. The material strand experiences a sheathing with thermoplastic material once again as a result of the additional feed of thermoplastic material inside chamber 3. In this way, it is possible to radially sheath elongated product 1 with at least two different thermoplastic materials. Thus, elongated product 1 could be sheathed directly with a thermoplastic material of a first kind in conical chamber KK and could additionally be radially enclosed inside chamber 3 with a thermoplastic material of a second kind. It is also possible to fill chamber 3 via conveying lines 7 and 7′ with a different thermoplastic material in each case.

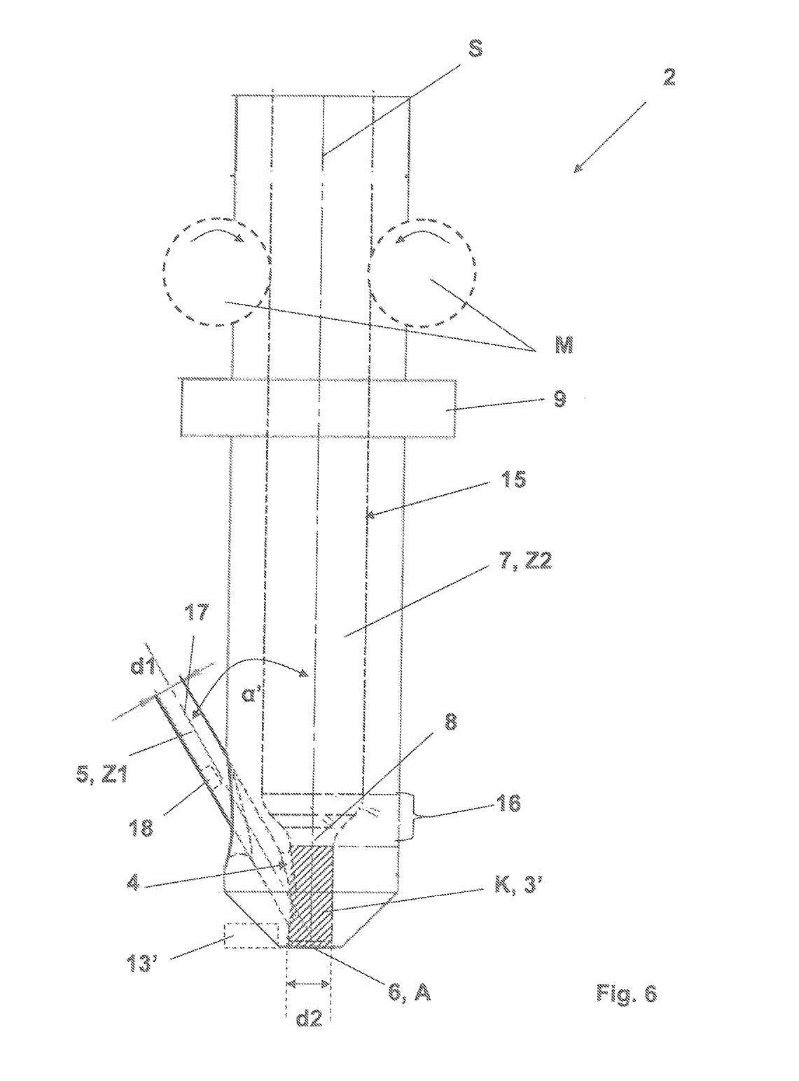

FIG. 6 shows a third example of embodiment for implementing a tool according to the invention for producing a heated, flowable thermoplastic strand, wherein an elongated product can be introduced as required in the fiber or a fiber bundle. For this purpose, wetting unit 2 provides a hollow-cylindrical section 15, preferably in the form of a metal hollow cylinder, which corresponds to second feeding area Z2, through which the solid strand-shaped thermoplastic, also available by the measured length, can be introduced. In the diagrammatic representation according to FIG. 6, it should be assumed that the solid thermoplastic strand, which is preferably cylindrical, is introduced from above into conveying line 7 of section 15, along which two transport devices M which are conveyor rollers are provided. Each roller is motor-driven and has an oppositely orientated direction of rotation, which causes the solid thermoplastic strand to be conveyed from top to bottom under the effect of force or pressure. A heating device 9 is provided along conveying line 7 for softening of the solid thermoplastic strand, to ensure that the thermoplastic guided along conveying line 7 is transformed into the flowable state in the lower region of conveying line 7.

Hollow-cylindrical section 15 of conveying line 7 has a largely constant channel cross-section, which continuously tapers in the lower region along transition region 16 to a smaller diameter corresponding to line opening 8. Line opening 8 is followed by contact zone K in a cylindrically constituted chamber 3′, which comprises a lower outlet opening 6. A common symmetrical axis S passes through hollow-cylindrical section 15 of conveying line 7 and also through transition region 16 as well as line opening 8 and outlet opening 6.

The thermoplastic strand available by the measured length (not represented) is conveyed along conveying line 7 by conveyor rollers M. The strand has a strand diameter which corresponds to the internal diameter of hollow-cylindrical section 15. This thus prevents softened and flowable thermoplastic material, which is formed in the conveying direction upstream of transition region 16, from escaping backwards against the conveying direction through hollow-cylindrical section 15. The softened thermoplastic material thus passes into transition region 16, as a result of the continuous tapering of the diameter whereof in the conveying direction the flowable thermoplastic material experiences a significant increase in pressure with a maximum conveying pressure in the region of line opening 8 during entry into chamber 3′ and passage through chamber 3′.

Feeding channel 5 of first feeding area Z1 emerges laterally into chamber 3′, through which feeding channel an elongated product (not represented in FIG. 6 and preferably in the form of a fiber bundle or an individual fiber, is fed without force. The provisioning of the fiber preferably takes place from a reservoir roll, from which the fiber stored as continuous elongated product is unwound free from force.

When the fiber which is fed along feeding channel 5 passes into the region of contact zone K, the fiber is taken up and carried along by the flowable thermoplastic strand on account of the occurring frictional forces and is ultimately delivered as a softened thermoplastic strand through outlet opening 6. The fiber or the fiber bundle has a fiber diameter or fiber bundle diameter that roughly corresponds to diameter d1 of feeding channel 5. In this way, the fiber itself ensures that escaped thermoplastic material cannot escape laterally through inlet opening 4, via which feeding channel 5 emerges into chamber 3. The dimensioning of outlet opening 6 is selected such that diameter d2 of outlet opening 6 is in principle selected greater than d1, whereby the following relationship preferably holds: 0.1 d2≦d1≦0.8 d2.

In order to avoid excessively small bending radii, which the fiber can undergo during the feeding and passage through wetting unit 2, channel axis 17 of the feeding channel 5 and axis of symmetry S form an angle α′, for which 10°≦α′≦80° holds.

A severing device can be provided along feeding channel 5 for interrupting the fiber feed, as can be seen for example from FIGS. 2a, 4 and 5. It is also possible to provide a corresponding severing device 13′ following or in the region of outlet opening 6, wherein it must also be ensured in this case that a corresponding fiber retaining device 18, preferably in the form of a clamping device, is provided at least along feeding channel 5, in order to prevent the end of the fiber emerging into chamber 3′ through inlet opening 4 from being carried along by the thermoplastic strand emerging through outlet opening 6. Having a severing device 13′ in the region of outlet opening 6 in combination with a corresponding fiber arresting device 18 along feeding channel 5, makes it possible to not have a conveying device described in connection with the above examples of embodiment according to FIGS. 2a, 4 and 5. If the feeding of the fiber along the exiting thermoplastic strand needs to be resumed, fiber retaining device 18 merely has to be released, as a result the fiber is again fed without force to chamber 3′, solely as a result of tractive forces acting along the fiber, which originate from material-based frictional-engagement forces occurring between the fiber and the softened thermoplastic material exiting from the outlet opening.

### LIST OF REFERENCE NUMBERS

A outlet area
K contact zone
KK conical chamber
AO receiving opening
M, M′ means for exerting pressure on a thermoplastic strand
Z1, Z1′ first feeding area
Z2, Z2′ second feeding area
MS material strand
A1 first axis
L line axis
KE notching device
K1, K1′ first hollow channel
K2, K2′ second hollow channel
Tₛ thermoplastic strand
T_{f} flowable thermoplastic
S axis of symmetry
1 elongated product
2 tool, wetting unit
3, 3′ chamber
4 inlet opening
5 feeding channel
6 outlet opening
7, 7′ conveying line
71 line section
8 line opening
9, 9′ heating arrangement
10 channel opening
11 additional line
13 severing device
14 conveyor
15 hollow-cylindrical section
16 transition region
17 channel axis
18 fiber retaining device

1-18. (canceled)

19. A tool for sheathing an elongated fiber product with at least one thermoplastic layer comprising:
a wetting unit including at least one contact zone which is filled with a flowable thermoplastic which wets the elongated fiber while the product continuously progresses through the at least one zone to at least one outlet area;
at least a first feeding area for providing the elongated fiber product into the at least one contact zone;
a second feeding area for providing the flowable thermoplastic material into the at least one contact zone from which the wetted elongated fiber product leaves the at least one contact zone; and
means, disposed at the second feeding area, for feeding the flowable thermoplastic under pressure into the at least one contact zone in a direction of flow toward the at least one outlet area with the elongated fiber product being guided lengthwise through the at least one contact zone and out through the outlet area solely by frictional force between the flowable thermoplastic and the elongated fiber product.

20. A tool according to claim 19, comprising:
a storage for loose elongated fiber product which is fed into the first feeding area without force.

21. A tool according to claim 19, comprising:
a heating device disposed at the at least one contact zone and/or at the second feeding area; and
the thermoplastic is fed as a solid material strand under force, through the second feeding area to a region of a heating device to transform the thermoplastic by heating into flowable thermoplastic.

22. A tool according to claim 20, comprising:
a heating device disposed at the at least one contact zone and/or at the second feeding area; and
the thermoplastic is fed as a solid material strand under force, through the second feeding area to a region of a heating device to transform the thermoplastic by heating into flowable thermoplastic.

23. A tool according to claim 19, wherein:
the contact zone includes a conical chamber which tapers in a direction of flow toward the outlet area.

24. A tool according to claim 20, wherein:
the contact zone includes a conical chamber which tapers in a direction of flow toward the outlet area.

25. A tool according to claim 21, comprising:
the contact zone includes a conical chamber which tapers in a direction of flow toward the outlet area.

26. A tool according to claim 23, wherein:
the conical chamber comprises a funnel-shaped receiving opening opposite the outlet area and the means for feeding introduces the thermoplastic under pressure into the at least one contact zone in the direction of flow toward the outlet area.

27. A tool according to claim 19, wherein:
the at least one contact zone comprises a cylindrical chamber.

28. A tool according to claim 20, wherein:
the at least one contact zone comprises a cylindrical chamber.

29. A tool according to claim 21, wherein:
the at least one contact zone comprises a cylindrical chamber.

30. A tool according to claim 23, wherein:
the at least one contact zone comprises a cylindrical chamber.

31. A tool according to claim 26, wherein:
the at least one contact zone comprises a cylindrical chamber.

32. A tool according to claim 23, wherein:
the means for feeding conveys a strand of solid thermoplastic, under force, in a direction of flow toward the outlet area of the chamber and the heating device is in thermal contact with the at least one contact zone to heat the solid thermoplastic into a flowable state in which the flowable thermoplastic exits as a material flow through the outlet area and surrounds and carries along the elongated fiber product in an interior thereof.

33. A tool according to claim 26, wherein:
the means for feeding conveys a strand of solid thermoplastic, under force, in a direction of flow toward the outlet area of the chamber and the heating device is in thermal contact with the at least one contact zone to heat the solid thermoplastic into a flowable state in which the flowable thermoplastic exits as a material flow through the outlet area and surrounds and carries along the elongated fiber product in an interior thereof.

34. A tool according to claim 28, wherein:
the means for feeding conveys a strand of solid thermoplastic, under force, in a direction of flow toward the outlet area of the chamber and the heating device is in thermal contact with the at least one contact zone to heat the solid thermoplastic into a flowable state in which the flowable thermoplastic exits as a material flow through the outlet area and surrounds and carries along the elongated fiber product in an interior thereof.

35. A tool according to claim 19, wherein:
the at least one contact zone is a chamber disposed inside the wetting unit;
the wetting unit comprises a feeding channel functioning as a first feeding area emerging via an inlet opening into a chamber and an outlet opening of the chamber;
the outlet opening is disposed opposite to and coaxial with the inlet opening into the chamber and has a larger diameter than the diameter of the inlet opening;
at least one conveying line providing a second feeding area which emerges from an opening of the chamber;
the means for conveying is disposed along the at least one conveying line which introduces, under pressure, the flowable thermoplastic into the chamber; and
the conveying line comprises a line section adjacent to the line opening having a line axis forming with the first axis an angle α with 10°≦α≦80°.

36. A tool according to claim 20, wherein:
the at least one contact zone is a chamber disposed inside the wetting unit;
the wetting unit comprises a feeding channel functioning as a first feeding area emerging via an inlet opening into a chamber and an outlet opening of the chamber;
the outlet opening is disposed opposite to and coaxial with the inlet opening into the chamber and has a larger diameter than the diameter of the inlet opening;
at least one conveying line providing a second feeding area which emerges from an opening of the chamber;
the means for conveying is disposed along the at least one conveying line which introduces, under pressure, the flowable thermoplastic into the chamber; and
the conveying line comprises a line section adjacent to the line opening having a line axis forming with the first axis an angle α with 10°≦α≦80°.

37. A tool according to claim 21, wherein:
the at least one contact zone is a chamber disposed inside the wetting unit;
the wetting unit comprises a feeding channel including a first feeding area from an inlet into the chamber and an outlet from the chamber;
the outlet opening is disposed opposite to and coaxial with an inlet opening and has a larger diameter than the diameter of the inlet opening;
at least one conveying line extending from an opening into the chamber;
the means for providing the flowable thermoplastic is disposed along the at least one conveying line for introducing, under pressure, flowable thermoplastic into the chamber; and
the chamber and the at least one line opening into the chamber provide flowable thermoplastic out of the conveying line through the line opening into the chamber with a flow direction toward the outlet opening.

38. A tool according to claim 35, wherein:
the inlet opening and outlet opening are aligned coaxial with a first axis;
the conveying line comprises a line section adjacent to the line opening having a line axis forming with the first axis an angle α with 10°≦α≦80°.

39. A tool according to claim 36, wherein:
the inlet opening and outlet opening are aligned coaxial with a first axis;
the conveying line comprises a line section adjacent to the line opening having a line axis forming with the first axis an angle α with 10°≦α≦80°.

40. A tool according to claim 37, wherein:
the inlet opening and outlet opening are aligned coaxial with a first axis;
the conveying line comprises a line section adjacent to the line opening having a line axis forming with the first axis an angle α with 10°≦α≦80°.

41. A tool according to claim 35, comprising:
a heating unit disposed along the conveying line.

42. A tool according to claim 36, comprising:
a heating unit disposed along the conveying line.

43. A tool according to claim 35, wherein:
the feeding channel comprises an opening opposite the inlet opening along the feeding channel; and
a severing device is disposed along the feeding channel for severing the elongated product guided inside the feeding channel.

44. A tool according to claim 38, wherein:
the feeding channel comprises an opening opposite the inlet opening along the feeding channel; and
a severing device is disposed along the feeding channel for severing the elongated product guided inside the feeding channel.

45. A tool according to claim 42, wherein:
the feeding channel comprises an opening opposite the inlet opening along the feeding channel; and
a severing device is disposed along the feeding channel for severing the elongated product guided inside the feeding channel.

46. A tool according to claim 43, comprising:
a conveyor disposed along the feeding channel for guiding the elongated product under force, along the feeding channel.

47. A tool according to claim 43, wherein:
the conveyor includes a compressed air source connected to a line emerging into the feeding channel; or
the conveyor includes a driven roller pair, for guiding the elongated fiber product by frictional engagement.

48. A tool according to claim 36, wherein:
the inlet opening of the feeding channel into the chamber is an outlet area of the conical chamber.

49. A tool according to claim 21, wherein:
the at least one contact zone includes a chamber inside the wetting unit;
the at least one conveying line emerges from an opening of the chamber and along which the means for providing introduces the flowable thermoplastic under pressure into the chamber;
the wetting unit includes at least one feeding channel into an opening of the chamber and an outlet opening from the chamber;
the outlet opening has a larger diameter than a diameter of the inlet opening; and
the chamber and the at least one opening pass the flowable thermoplastic out of the conveying line through the line opening into the chamber in a flow direction directed toward the outlet opening.

50. A tool according to claim 49, wherein:
the conveying line comprises a hollow-cylindrical section, along which a conveying-roller or a roller pair each with an oppositely driven direction of rotation, engage both sides a solid thermoplastic strand, to feed the strand through the conveying line in a direction toward the chamber;
the hollow-cylindrical section has a larger internal diameter than the diameter of the line opening, wherein the internal diameter of the hollow-cylindrical section tapers continuously in a transition region to the diameter of the line opening;
a common axis passes through the hollow-cylindrical section, the transition region, the line opening, the chamber and the outlet opening; and
the at least one feeding channel for the elongated fiber product has a channel axis which forms an angle α′ with the axis of symmetry, for which the following holds:
10°<=α<=80°.

51. A tool according to claim 19, wherein:
the wetting unit is a portable unit and is in one-piece.

52. A method for sheathing an elongated fiber or fiber bundle product with at least one thermoplastic layer, wherein the elongated fiber or fiber bundle product is a continuously progressing strand guided through a contact zone that can be filled with a flowable thermoplastic and via an outlet from of the contact zone, comprising:
introducing the flowable thermoplastic, subject to pressure, into the contact zone with a predetermined flow direction in the direction of the outlet; and
the elongated fiber or fiber bundle product is drawn through the contact zone by frictional forces which act between the elongated fiber or fiber bundle product and the flowable thermoplastic inside the chamber.

53. A method according to claim 52, comprising:
threading the elongated product into the contact zone without force acting along the elongated fiber product or fiber bundle.
